(19) United States
(12) Patent Application Publication
(10) Pub. No.: US 2008/0130113 A1
(43) Pub. Date: Jun. 5, 2008

(54) OPTICAL PLATE HAVING THREE LAYERS AND MICRO PROTRUSIONS

(75) Inventors: TUNG-MING HSU, Tu-Cheng (TW); SHAO-HAN CHANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/620,958

(22) Filed: Jan. 8, 2007

(30) Foreign Application Priority Data
Dec. 1, 2006 (CN) 200610201176.9

(51) Int. Cl. G02B 5/02

(52) U.S. Cl. 359/599; 359/831

(57) ABSTRACT

An optical plate includes a first transparent layer, a second transparent layer and a light diffusion layer between the first and second transparent layers. The above-described three layers are integrally formed, with the first transparent layer in immediate contact with the light diffusion layer, and the second transparent layer in immediate contact with the light diffusion layer. The first transparent layer defines many of micro protrusions protruding from an outer surface thereof. Each micro protrusion has at least three flat side surfaces connected to each other, and a transverse width of each side surface decreases along a direction away from the light diffusion layer. The second transparent layer defines many of V-shaped protrusions at an outer surface thereof.

### BACKGROUND OF THE INVENTION

1. Field of the Invention

The present invention generally relates to optical plates, and more particularly, to an optical plate for use in, for example, a liquid crystal display (LCD).

2. Discussion of the Related Art

The lightness and slimness of LCD panels make them suitable for a wide variety of uses in electronic devices such as personal digital assistants (PDAs), mobile phones, portable personal computers, and other electronic appliances. Liquid crystal is a substance that cannot emit light by itself. Instead, the liquid crystal relies on reflecting light from a light source in order to display data images. In the case of a typical LCD panel, an optical plate powered by electricity supplies the needed light.

FIG. 7 is an exploded, side cross-sectional view of a typical backlight module 10 employing a typical optical diffusion plate. The backlight module 10 includes a housing 11, a plurality of lamps 12 disposed on a base of the housing 11, and a light diffusion plate 13 and a prism sheet 15 stacked on the housing 11 in that order. The lamps 12 emit light rays, and inside walls of the housing 11 are configured for reflecting some of the light rays upwards. The light diffusion plate 13 includes a plurality of dispersion particles. The dispersion particles are configured for scattering received light rays and thereby enhancing the uniformity of light rays that exit the light diffusion plate 13. The prism sheet 15 includes a plurality of V-shaped structures on a top thereof. The V-shaped structures are configured for collimating received light rays to a certain extent.

In use, the light rays from the lamps 12 enter the prism sheet 15 after being scattered in the diffusion plate 13. The light rays are refracted by the V-shaped structures of the prism sheet 15 and are thereby concentrated so as to increase brightness of light illumination. Finally, the light rays propagate into an LCD panel (not shown) disposed above the prism sheet 15. Even though the diffusion plate 13 and the prism sheet 15 are in contact with each other, a plurality of air pockets still existing at the boundary therebetween. When the backlight module 10 is in use, light passes through the air pockets, and some of the light undergoes total reflection at one or another of the corresponding boundaries. As a result, the light energy utilization ratio of the backlight module 10 is reduced.

Therefore, a new optical plate is desired in order to overcome the above-described shortcomings.

### SUMMARY

An optical plate includes a first transparent layer, a second transparent layer and a light diffusion layer between the first and second transparent layers. The light diffusion layer includes a transparent matrix resin and a plurality of diffusion particles dispersed in the transparent matrix resin. The first transparent layer, the light diffusion layer, and the second transparent layer are integrally formed, with the first transparent layer in immediate contact with the light diffusion layer, and the second transparent layer in immediate contact with the light diffusion layer. The first transparent layer defines a plurality of micro protrusions protruding from an outer surface thereof distalmost from the second transparent layer. Each micro protrusion has at least three flat side surfaces connected to each other, and a transverse width of each side surface decreases along a direction away from the light diffusion layer. The second transparent layer defines a plurality of V-shaped protrusions at an outer surface thereof distalmost from the first transparent layer.

Other novel features and advantages will become more apparent from the following detailed description, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present optical plate. Moreover, in the drawings, like reference numerals designate corresponding parts throughout the several views, and all the views are schematic.

FIG. 1 is an isometric view of an optical plate in accordance with a first embodiment of the present invention.

FIG. 2 is a cross-sectional view of the optical plate of FIG. 1, taken along line II-II thereof.

FIG. 3 is a cross-sectional view of the optical plate of FIG. 1, taken along line III-III thereof.

FIG. 4 is an isometric view of an optical plate in accordance with a second embodiment of the present invention.

FIG. 5 is an isometric view of an optical plate in accordance with a third embodiment of the present invention.

FIG. 6 is a side cross-sectional view of an optical plate in accordance with a fourth embodiment of the present invention.

FIG. 7 is an exploded, side cross-sectional view of a conventional backlight module having a prism sheet and a light diffusion plate.

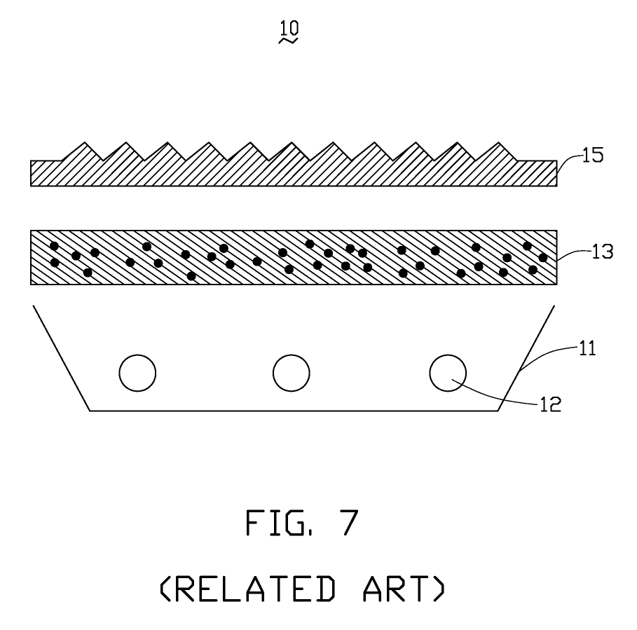

### DETAILED DESCRIPTION OF THE EMBODIMENTS

Reference will now be made to the drawings to describe preferred embodiments of the present optical plate, in detail.

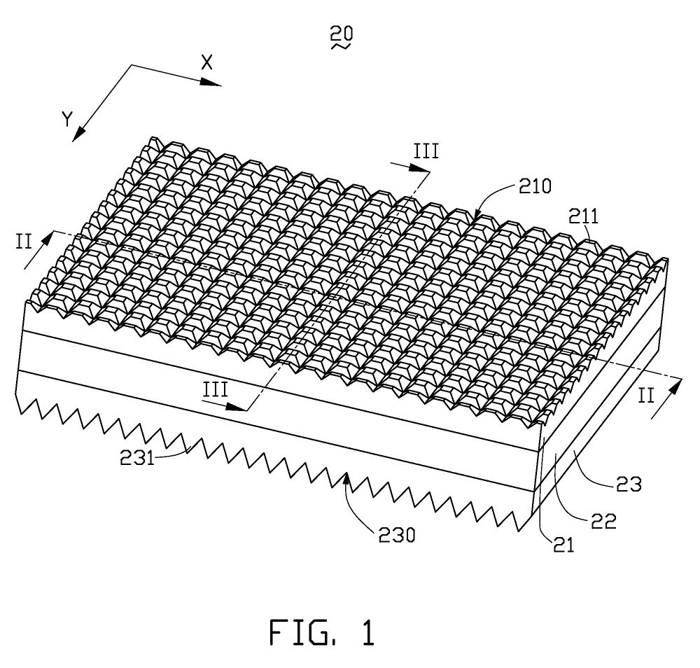

Referring to FIG. 1, an optical plate 20 according to a first embodiment is shown. The optical plate 20 includes a first transparent layer 21, a light diffusion layer 22, and a second transparent layer 23. The light diffusion layer 22 is between the first and second transparent layers 21, 23. The first transparent layer 21, the light diffusion layer 22, and the second transparent layer 23 are integrally formed by multi-shot injection molding technology. That is, the first transparent layer 21 and the light diffusion layer 22 are in immediate contact with each other at a common interface thereof, and the second transparent layer 23 and the light diffusion layer 22 are in immediate contact with each other at a common interface thereof. The second transparent layer 23 defines a plurality of V-shaped protrusions 231 at an outer surface 230 thereof distalmost from the first transparent layer 21. The first transparent layer 21 defines a plurality of micro protrusions 211 protruding out from an outer surface 210 thereof distalmost from the second transparent layer 23. Each of the micro protrusions 211 includes at least three side surfaces connected to each other. A horizontal width of each side surface decreases along a direction away from the light diffusion layer 22. The micro protrusions 211 of the first transparent layer 21 are configured for collimating the emitted light rays, thereby improving the brightness of light illumination.

In the illustrated embodiment, each V-shaped protrusion 231 is an elongated ridge extending along a Y-axis. That is, each V-shaped protrusion 231 extends along a direction parallel to a long side surface of the optical plate 20. The V-shaped protrusions 231 are aligned end to end along an X-axis on the outer surface 230 of the second transparent layer 23, with the lines of V-shaped protrusions 231 being parallel to each other. Further, each V-shaped protrusion 231 in each line is adjacent a corresponding V-shaped protrusion 231 in each of the adjacent lines. Thus, a regular matrix of the V-shaped protrusions 231 is formed on the outer surface 230. A pitch P₂ between two adjacent V-shaped protrusions 231 is in the range from about 0.025 millimeters to 1 millimeter. A vertex angle θ of each of the V-shaped protrusions 231 is in the range from about 60 degrees to about 120 degrees. It is to be understood that the V-shaped protrusions 211 can be configured otherwise. For example, each of the V-shaped protrusions 211 can instead be a right-angled triangle prism, with one face of the prism parallel to the side surface of the optical plate 20, and another face of the prism generally facing toward but slanted relative to an opposite side surface of the optical plate 20.

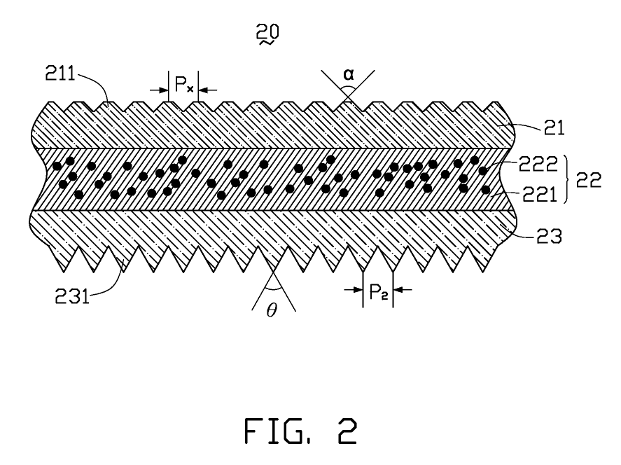

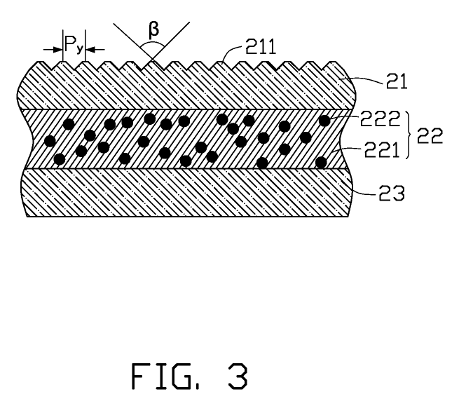

In the illustrated embodiment, the micro protrusions 211 are arranged regularly on the outer surface 230 in a matrix. Each of micro protrusions 211 is frusto-pyramidal, and includes four side surfaces (not labeled). Each of the side surfaces of the micro protrusion 211 is an isosceles trapezium. Pₓ represents a pitch between two adjacent micro protrusions 211 aligned along the X-axis, as shown in FIG. 2. P_{y} represents a pitch between two adjacent micro protrusions 211 aligned along the Y-axis, as shown in FIG. 2. Each of Pₓ and P_{y} is configured to be in the range from about 0.025 millimeters to about 1 millimeter. Pₓ and P_{y} can be equal to each other or different from each other. In the illustrated embodiment, Pₓ is larger than P_{y}. Referring to FIGS. 1 and 2, an angle α is defined by an intersecting angle between a first pair of opposite side surfaces of each micro protrusion 211 whose planes are parallel to the Y-axis. Referring to FIGS. 1 and 3, an angle β is defined by an intersecting angle between a second pair of opposite side surfaces of each micro protrusion 211 whose planes are parallel to the X-axis. Eight of the angles α and β is configured to be in the range from about 60 degrees to about 120 degrees. The angles α, β can be equal to each other or different from each other. In the illustrated embodiment, the angle α is equal to the angle β.

A thickness of each of the first transparent layer 21, the light diffusion layer 22, and the second transparent layer 23 may be greater than or equal to 0.35 millimeters. In a preferred embodiment, a combined thickness of the first transparent layer 21, the light diffusion layer 22, and the second transparent layer 23 is in the range from about 1.05 millimeters to about 6 millimeters. The first transparent layer 21 and the second transparent layer 23 are each made of transparent matrix resin selected from the group including polyacrylic acid (PAA), polycarbonate (PC), polystyrene (PS), polymethyl methacrylate (PMMA), methylmethacrylate and styrene (MS), and any suitable combination thereof. It should be pointed out that materials of the first and second transparent layers 21, 23 can be the same material, or can be different materials.

The light diffusion layer 22 includes a transparent matrix resin 221, and a plurality of diffusion particles 222 dispersed in the transparent matrix resin 221. The light diffusion layer 22 is configured for enhancing optical uniformity. The transparent layer 221 is made of transparent matrix resin selected from the group including polyacrylic acid (PAA), polycarbonate (PC), polystyrene (PS), polymethyl methacrylate (PMMA), methylmethacrylate and styrene (MS), and any suitable combination thereof. The diffusion particles 222 can be made of material selected from the group including titanium dioxide, silicon dioxide, acrylic resin, and any combination thereof. The diffusion particles 222 are configured for scattering light rays and enhancing a light distribution capability of the light diffusion layer 22. The light diffusion layer 22 preferably has a light transmission ratio in the range from 30% to 98%. The light transmission ratio of the light diffusion layer 22 is determined by a composition of the transparent matrix resin 221 and the diffusion particles 222.

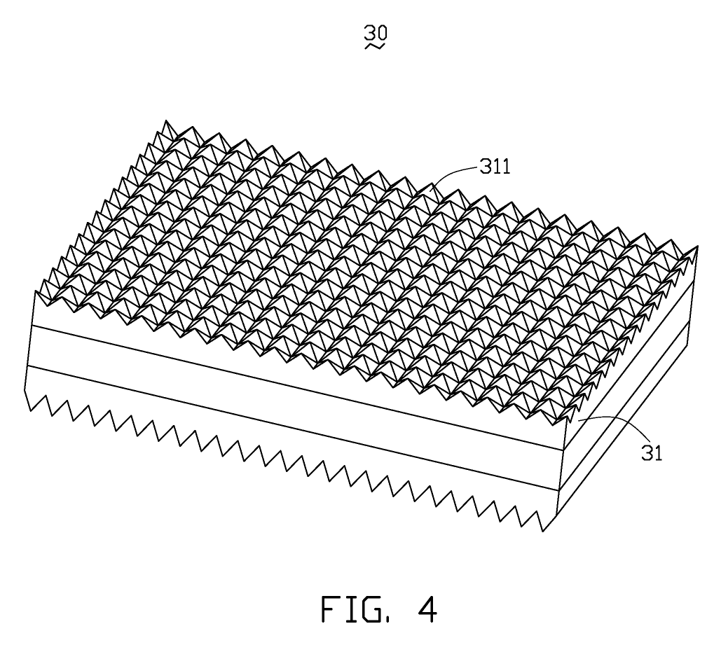

Referring to FIG. 4, an optical plate 30 according to a second embodiment is shown. The optical plate 30 is similar in principle to the optical plate 20 of the first embodiment, except that each of micro protrusions 311 of a first transparent layer 31 is a four-sided pyramid.

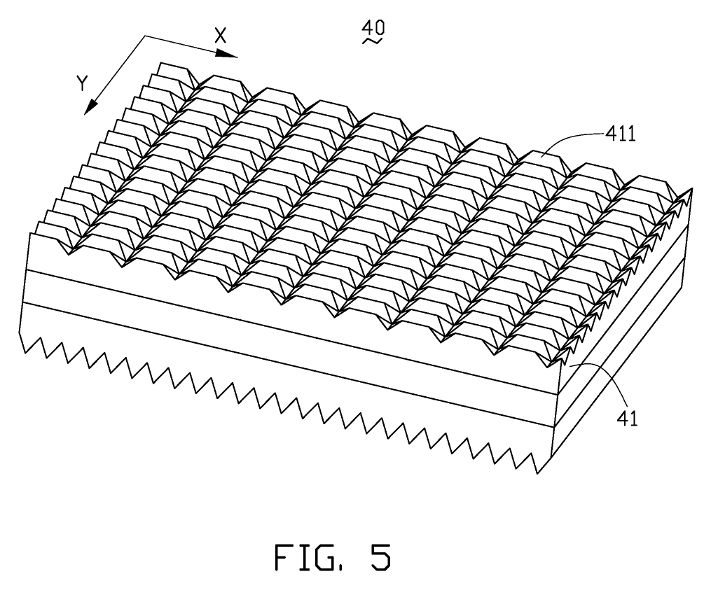

Referring to FIG. 5, an optical plate 40 according to a third embodiment is shown. The optical plate 40 is similar in principle to the optical plate 20 of the first embodiment, except that each of micro protrusions 411 of a first transparent layer 41 is a polyhedron that includes four side surfaces. A first pair of opposite side surfaces of the four side surfaces is isosceles triangles with planar surfaces parallel to a Y-axis. A second pair of opposite side surfaces of the four side surfaces is isosceles trapeziums with planar surfaces parallel to an X-axis.

In the above-described embodiments, an interface between the light diffusion layer and either of the first and second transparent layers is flat. Alternatively, the interface between the light diffusion layer and the first transparent layer or between the light diffusion layer and the second transparent layer may be other shapes such as non-planar surfaces.

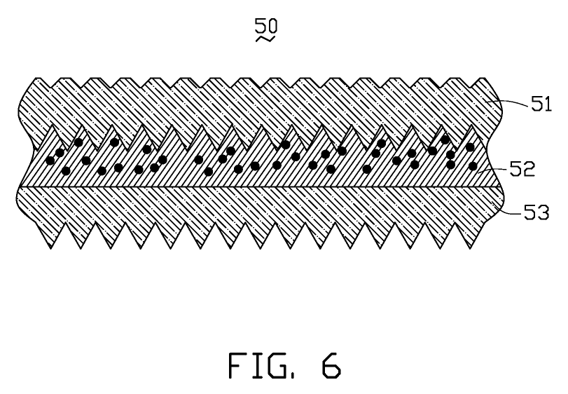

Referring to FIG. 6, an optical plate 50 according to a fourth embodiment is shown. The optical plate 50 includes a first transparent layer 51, a light diffusion layer 52, and a second transparent layer 53. The optical plate 50 is similar in principle to the optical plate 20 of the first embodiment, except that an interface (not labeled) between the first transparent layer 51 and the light diffusion layer 52 is jagged. Therefore an area of mechanical engagement between the first transparent layer 51 and the light diffusion layer 52 is increased, and a strength of the mechanical engagement between the first transparent layer 51 and the light diffusion layer 52 is correspondingly increased.

Operation and functioning of the optical plate 20 of the first embodiment is as follows. When the optical plate 20 is used in a backlight module, either the first transparent layer 21 or the second transparent layer 23 of the optical plate 20 can be assembled to face light sources in the backlight. Light rays from the light sources directly enter the optical plate 20 via the first transparent layer 21 or the second transparent layer 23.

When the light rays enter the optical plate 20 via the second transparent layer 23, the light rays are diffused by the V-shaped protrusions 231 of the second transparent layer 23. Then the light rays are substantially further diffused in the light diffusion layer 22 of the optical plate 20. Finally, many or most of the light rays are condensed by the micro protrusions 211 of the first transparent layer 21 before they exit the optical plate 20. As a result, a brightness of the backlight module can be increased. In addition, the light rays are diffused twice, so that an optical uniformity of the optical plate 20 is enhanced. Moreover, the first transparent layer 21, the light diffusion layer 22, and the second transparent layer 23 are integrally formed together (see above), with no air or gas pockets trapped in the respective interfaces therebetween. Thus the efficiency of utilization of light rays is increased. Furthermore, when the optical plate 20 is assembled into a backlight module, the optical plate 20 in effect replaces the conventional combination of a diffusion plate and a prism sheet. Therefore compared with conventional art, a process of assembly of the backlight module is simplified and the efficiency of assembly is improved. Moreover, in general, a space occupied by the optical plate 20 is less than that occupied collectively by the conventional combination of a diffusion plate and a prism sheet. Thus a size of the backlight module can also be reduced.

When the light rays enter the optical plate 20 via the first transparent layer 21, the optical uniformity of the optical plate 20 is also enhanced, and the utilization efficiency of light rays is also increased. While, the light rays emitted from the optical plate 20 via the second transparent layer 23 are different from the light rays emitted from the optical plate 20 via the first transparent layer 21. For example, when the light rays enter the optical plate 20 via the second transparent layer 23, a viewing angle of a liquid crystal display device using the backlight module is somewhat larger than that of the liquid crystal display module when the light rays enter the optical plate 20 of the backlight module via the first transparent layer 21.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. An optical plate, comprising;
a first transparent layer;
a second transparent layer; and
a light diffusion layer between the first transparent layer and the second transparent layer, the light diffusion layer including a transparent matrix resin and a plurality of diffusion particles dispersed in the transparent matrix resin, wherein the light diffusion layer, the first transparent layer, and the second transparent layer are integrally molded together, with the first transparent layer in immediate contact with the light diffusion layer and the second transparent layer in immediate contact with the light diffusion layer such that there are no air or gas pockets trapped between the first transparent layer and the light diffusion layer nor between the second transparent layer and the light diffusion layer, the first transparent layer defines a plurality of micro protrusions protruding from an outer surface thereof farthest from the second transparent layer, each micro protrusion has at least three flat side surfaces connected to each other, and a transverse width of each side surface decreases along a direction away from the light diffusion layer, and the second transparent layer defines a plurality of V-shaped protrusions at an outer surface thereof farthest from the first transparent layer.

2. The optical plate as claimed in claim 1, wherein a thickness of each of the light diffusion layer, the first transparent layer, and the second transparent layer is greater than or equal to 0.35 millimeters.

3. The optical plate as claimed in claim 2, wherein a combined thickness of the light diffusion layer, the first transparent layer, and the second transparent layer is in the range from about 1.05 millimeters to 6 millimeters.

4. The optical plate as claimed in claim 1, wherein the first and second transparent layers are made of material selected from the group consisting of polyacrylic acid, polycarbonate, polystyrene, polyrnethyl methacrylate, methylmethacrylate and styrene, and any combination thereof.

5. The optical plate as claimed in claim 1, wherein a pitch between two adjacent V-shaped protrusions is in the range from about 0.025 millimeters to 1 millimeter.

6. The optical plate as claimed in claim 5, wherein a vertex angle of each V-shaped protrusion is in the range from about 60 degrees to about 120 degrees.

7. The optical plate as claimed in claim 1, wherein the micro protrusions are one of frusto-pyramidal protrusions, four-sided pyramids, and protrusions having four side surfaces, and each of said protrusions having four side surfaces comprises a pair of opposite side surfaces parallel to a first direction, said pair of opposite side surfaces being isosceles triangles, and another pair of opposite side surfaces parallel to a second direction, said another pair of opposite side surfaces being isosceles trapeziums, and the first direction is perpendicular to the second direction.

8. The optical plate as claimed in claim 7, wherein a pitch between two adjacent micro protrusions along the first direction or the second direction is in the range from about 25 microns to 1 millimeter.

9. The optical plate as claimed in claim 7, wherein an angle defined by one pair of opposing side surfaces of each micro protrusion is in the range from about 60 degrees to about 120 degrees.

10. The optical plate as claimed in claim 1, wherein an interface between the light diffusion layer and one of the first and second transparent layers is flat.

11-12. (canceled)

13. The optical plate as claimed in claim 1, wherein the transparent matrix resin is selected from the group consisting of polyacrylic acid, polycarbonate, polystyrene, polymethyl methacrylaze, methylmethacrylate and styrene (MS), and any combination thereof.

14. The optical plate as claimed in claim 1, wherein a material of the diffusion particles is selected from the group consisting of titanium dioxide, silicon dioxide, acrylic resin, and any combination thereof.

15. The optical plate as claimed in claim 1, wherein at least one of the following interfaces is jagged: an interface between the light diffusion layer and the first transparent layer, and an interface between the light diffusion layer and the second transparent layer.
